(19) United States
(12) Patent Application Publication
(10) Pub. No.: US 2017/0176032 A1
(43) Pub. Date: Jun. 22, 2017

(54) VIRTUAL FLOW MEASUREMENT SYSTEM

(71) Applicant: Carrier Corporation, Farmington, CT (US)

(72) Inventors: Jinliang Wang, Ellington, CT (US); Ashutosh Tewari, Wethersfield, CT (US); Mikhail B. Gorbounov, South Windsor, CT (US)

(21) Appl. No.: 15/344,369

(22) PCT Filed: Mar. 5, 2015
(86) PCT No.: PCT/US2015/018885

§ 371 Date: Nov. 4, 2016

Related U.S. Application Data
(60) Provisional application No. 61/988,377, filed on May 5, 2014.

(51) Int. Cl. F24F 11/00; G01K 13/02; G01N 25/18

(52) U.S. Cl. CPC F24F 11/006; G01N 25/18; G01K 13/02; F24F 11/0012; F24F 2011/0063; F24F 2011/0091; F24F 2011/0082

(57) ABSTRACT

An HVAC thermal energy flow measurement system includes a computerized virtual fluid flow measurement system configured to estimate a fluid flow within at least a portion of the HVAC system based on at least one HVAC system condition, and at least one HVAC system sensor for sensing the at least one HVAC system condition, wherein the HVAC system sensor is operatively connected to the virtual flow measurement system to provide the virtual flow measurement system with the at least one HVAC system condition.

### RELATED APPLICATIONS

This application claims the benefit of and priority to U.S. Provisional Patent Application No. 61/988,377 filed May 5, 2014, the contents of which are incorporated herein by reference in their entirety.

### STATEMENT OF FEDERALLY FUNDED RESEARCH

Portions of this disclosure may have been reduced to practice with funding provided by the U.S. federal government under Department of Energy Grant No. DE-EE-0004261. Accordingly, the federal government may have certain rights to portions of this disclosure.

### BACKGROUND

1. Field

The present disclosure relates to thermal metering flow measurement, more specifically to systems for virtual flow measurement.

2. Description of Related Art

Achieving energy independence relies not only on exploring new energy resources including renewable and nonrenewable but also on energy saving and waste energy recovery. Commercial and residential buildings consume roughly 40% of all US energy use and play a key role in the energy market. Building energy information and management systems are essential to monitor and optimize energy usage in buildings including commercial and residential structures. It is required to measure effectively all energy flows in buildings including thermal energy for heating, cooling, and other purposes to increase energy efficiency.

Thermal energy meters, also called BTU (British Thermal Unit) meters, are widely used in building energy auditing and commissioning. Typical BTU meters get thermal energy consumption through measuring fluid flow rate and fluid temperatures at supply and return lines. Fluid flow rate measurement is the major part of the BTU meter. It dominates the total BTU meter cost in material, installation and calibration. Fluids used in building HVAC systems usually are water, refrigerants and air. There are many flow rate measurement instruments, such as rotameters, Venturis/nozzles, rotary vanes, turbines, ultrasonic and magnetic flowmeters, and the like.

In centralized HVAC systems for commercial and residential buildings BTU meters usually are highly accurate turbine or ultrasonic flow meters. However, the cost for such accurate systems can be considerable. This becomes a major barrier for BTU meter applications in building energy monitoring and management systems. Thus, most buildings do not have BTU meters installed due to the cost. For example, there is an ever present need for BTU meters with greater accuracy and/or at a lower cost.

Such conventional methods and systems have generally been considered satisfactory for their intended purpose. However, there is still a need in the art for low cost energy management systems, e.g., for buildings. The present disclosure provides solutions for this need.

### SUMMARY

In at least one aspect of this disclosure, an HVAC thermal energy flow measurement system includes a computerized virtual fluid flow measurement system configured to estimate a fluid flow within at least a portion of the HVAC system based on at least one HVAC system condition, and at least one HVAC system sensor for sensing the at least one HVAC system condition, wherein the HVAC system sensor is operatively connected to the virtual flow measurement system to provide the virtual flow measurement system with the at least one HVAC system condition.

The system can further include a physical or mathematical model, stored in a non-transitory computer readable medium therein, that represents the fluid flow for determining the fluid flow based on the at least one HVAC system condition.

The system can further include an empirical or statistical model, stored in a non-transitory computer readable medium therein, for determining the fluid flow based on the at least one HVAC system condition, wherein the fluid flow is determined by comparing the at least one HVAC system condition to known flow data.

The system can further include at least a portion of a physical or mathematical model, stored in a non-transitory computer readable medium therein, that at least partially represents the fluid flow, and at least a portion of an empirical or statistical model, stored in a non-transitory computer readable medium therein, for determining the fluid flow based on the at least one HVAC system condition, wherein the fluid flow is determined by inputting the physical condition into the physical model and comparing the at least one HVAC system condition to known flow data.

The HVAC system sensor can include at least one temperature sensor in thermal communication with at least a portion of the fluid flow. The at least one temperature sensor can include at least two temperature sensors. The at least two temperature sensors can include an inlet temperature sensor disposed in thermal communication with a first portion of the HVAC and an outlet temperature sensor disposed in thermal communication with a second portion of the HVAC.

The thermal energy flow measurement system can be configured to determine thermal energy flow using the fluid flow and a signal from each of the inlet and outlet temperature sensors.

In at least one aspect of this disclosure, a non-transitory computer readable medium can include computer executable instructions comprising the steps of receiving at least one HVAC system condition from an HVAC system sensor, inputting the at least one HVAC system condition from the HVAC system sensor into a virtual fluid flow system to determine a fluid flow of at least a portion of the HVAC system, outputting a fluid flow value, and determining thermal energy flow using at least the fluid flow.

Inputting can further include inputting the at least one HVAC system condition into a physical or mathematical model that represents the fluid flow for determining the fluid flow based on the at least one HVAC system condition.

Inputting can further include further includes inputting the at least one HVAC system condition into a statistical model for determining the fluid flow based on the at least one HVAC system condition.

In at least one aspect of this disclosure, a method for measuring thermal energy flow in an HVAC system includes receiving at least one parameter or variable from the HVAC system, inputting the at least one parameter or variable from the HVAC system into a virtual fluid flow system to determine a fluid flow of at least a portion of the HVAC, outputting a fluid flow value; and determining thermal energy flow using at least the fluid flow and a sensed temperature.

The sensed temperatures can include a first sensed temperature and a second sensed temperature from two different locations along a flow path of the fluid flow.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a schematic view of a hot or cold water flow network of a centralized HVAC system in accordance with this disclosure, showing several branches and portions of an HVAC system;

FIG. 2 is a diagram showing an embodiment of a method for using an embodiment of the physics based fluid flow meter in accordance with this disclosure;

FIG. 3 is a schematic depicting an embodiment of a physics based flow meter model applied to the system of FIG. 1 in accordance with this disclosure, showing a system pressure network model, a pump, a plurality of AHUs and a bypass valve;

FIG. 4 is a schematic depicting an embodiment of a statistical based flow meter approach applied to the system of FIG. 1 in accordance with this disclosure, showing a system pressure network model, a pump, a plurality of AHUs and a bypass valve; and

FIG. 5 is a schematic showing a portion of a branch of a system modeled by the statistical based flow meter approach of FIG. 4.

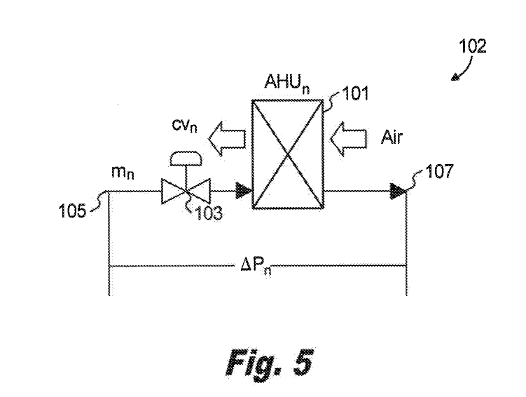

### DETAILED DESCRIPTION

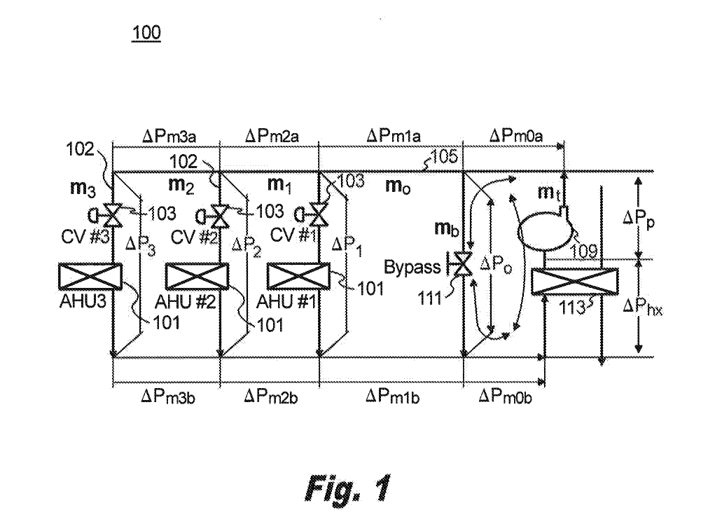

Reference will now be made to the drawings wherein like reference numerals identify similar structural features or aspects of the subject disclosure. An example embodiment of an HVAC system is shown in FIG. 1. Disclosed herein are systems and methods for virtually determining a fluid flow rate in an HVAC system without the use of a flow meter. The virtually determined fluid flow rate can be used to determine energy/heat transfer of the HVAC system.

In centralized HVAC systems building heating and cooling are usually realized through hydronic systems in which water circulates between chillers/boilers and Air Handling Units (AHU). BTU metering for both cooling and heating operations is typically accomplished from the water side and can require knowledge of its inlet/outlet temperatures, and/or mass flow rates.

In some embodiments, measuring fluid flow rates in accordance with this disclosure is accomplished using a virtual flow system that includes a physics based flow meter developed through system flow network modeling. In certain embodiments, measuring fluid flow rates at low cost is accomplished using a virtual flow system that includes a hybrid flow network modeling and data driven mapping. Measuring fluid flow rates at low cost can be accomplished using a virtual flow system that employs only statistical/empirical data driven approaches. Examples of this are described in more detail below.

Referring to FIG. 1, a typical hot or cold water flow network of a centralized HVAC system 100 is shown. Multiple AHU 101 and control valve 103 combinations can be distributed along a main supply line 105 and a main return line 107. One or more pumps 109 circulate chilled or hot water (and/or any other suitable fluid) along the system 100 while a bypass valve 111 maintains system static pressure by adjusting its opening.

### Physics Based Flow Meter Embodiments

Referring to FIG. 1, for each AHU branch 102, flow rate mₙ can be determined through the following relationships:

mₙ=ρₙAₙVₙ,

where mₙ is the mass flow rate of branch n wherein is the branch number such that n=0, 1, 2, 3, . . . up to the total amount of branches 102 in the system 100, ρₙ is density of the fluid of branch n, Aₙ is the cross-sectional area that the fluid is flowing through of branch n, Vₙ is the velocity of the fluid in branch n;

ΔPₙ₋₁=ΔPₙ+ΔPₘₙₐ+ΔP_{mnb},

where ΔPₙ is the pressure drop over branch n, ΔPₙ₋₁ is the pressure drop over branch n−1, ΔPₘₙₐ is the pressure drop over a portion of the supply line 105 spanning from branch n−1 to branch n, ΔP_{mnb} is the pressure drop over a portion of the return line 107 spanning from branch n to branch n−1; and

$$Δ P = \sum ρ gH + 4 \sum f \frac{L}{d} \frac{ρ {V}^{2}}{2} + \sum K \frac{ρ {V}^{2}}{2}$$

where ΔP is the total pressure drop in system 100, where ΣρgH represents the static head of the system 100 (e.g., the sum of static pressures in each portion of the system 100), where ρ is the density of the fluid in the system 100, g is the acceleration due to gravity acting on the system, H is the height that the fluid rises above an initial height in at least a portion of the system 100, wherein

$$4 \sum f ( \frac{L}{d} ) \frac{ρ {V}^{2}}{2}$$

represents the total frictional loss in system 100 (e.g., a summation of frictional forces present in system 100), where f is the frictional constant for a portion system 100, L is the length of a segment of the system 100, d is the diameter of a portion of the system 100, ρ is density of the fluid, V is the velocity of the fluid, and where

$$\sum K \frac{ρ {V}^{2}}{2}$$

represents the fitting/splitting local losses in the system 100, where K is the local loss coefficient, ρ is density of the fluid, V is the velocity of the fluid.

For the pump, mass flow rate mₜ can be determined through the following relationships:

$$\{ \begin{matrix}Δ {P}_{pump} = Δ {P}_{0} + Δ {P}_{m 0 a} + Δ {P}_{m 0 b +} Δ {P}_{hx} \\ {m}_{t} = {f}_{t} ( Δ {P}_{pump} ) \\ Δ {P}_{hx} = {F}_{hx} ( {m}_{t} )\end{matrix}$$

where ΔPₚᵤₘₚ is the pressure drop over pump 109, ΔP₀ is the pressure drop over the bypass valve 111, ΔPₘ₀ₐ is the pressure drop over a portion of the supply line 105 spanning from the pump 109 branch to the bypass 111 branch, ΔP_{m0b} is the pressure drop over a portion of the return line 107 spanning from the bypass 111 branch to the pump 109/heat exchanger 113 branch, and ΔPₕₓ is the pressure drop over the heat exchanger 113, where mₜ is a function fₜ of ΔPₚᵤₘₚ that can be determined using empirical pump data (e.g., data provided by manufacturers) or any other suitable means, and where ΔPₕₓ is a function Fₕₓ of mₜ depending on the heat exchanger characteristics.

For the bypass valve 111, mass flow rate m_{b} can be determined through the following relationship:

m_{b}=f_{b}(ΔP₀,x)

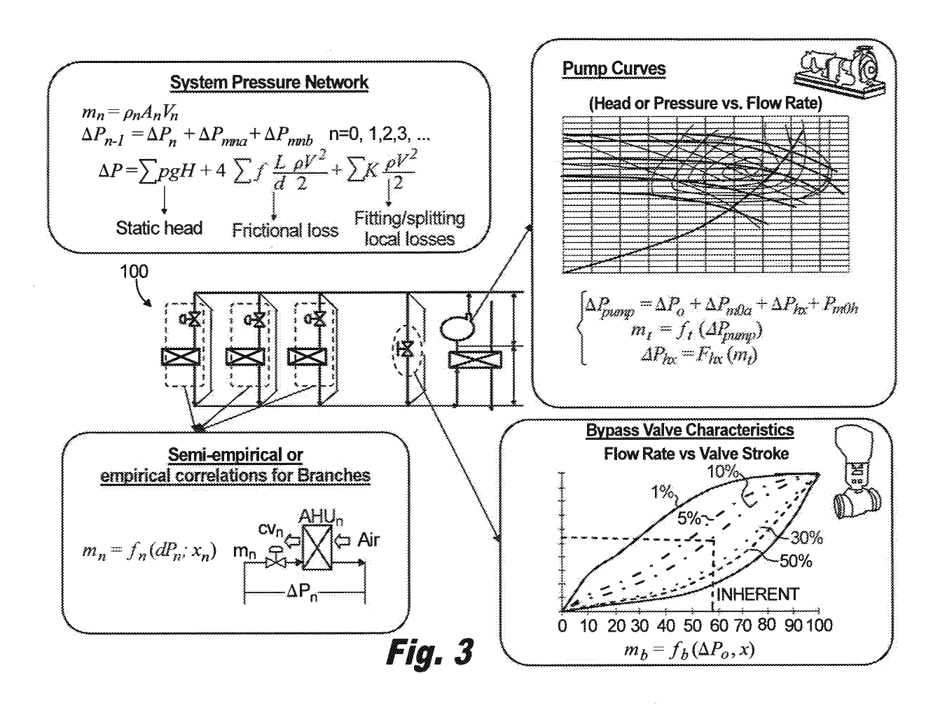

such that m_{b} is a function f_{b} of ΔP₀ and variable x, wherein x is the percentage of valve opening. As shown in FIG. 3, m_{b} can be determined using data regarding percentage flow vs. percentage of valve opening of the bypass valve 111.

By using the relationships described above, a flow network model can be constructed for system 100. After building the flow network model, fluid flow rates (e.g., water flow rate) through each branch 102 can be mapped out. By using a temperature sensor to determine temperatures at the inlet and outlet of each branch, thermal energy flow Qₙ for a branch n can be calculated as follows:

Qₙ=mₙCₚ(Tₙ_{_}ᵢₙ−Tₙ_{_}ₒᵤₜ),

where mₙ is the mass flow rate of branch n, Cₚ is specific heat of the fluid at a constant pressure, Tₙ_{_}ᵢₙ is the temperature at the inlet of branch n, and Tₙ_{_}ₒᵤₜ is the temperature of the outlet of branch n. Total thermal energy flow Q of the system 100 can be calculated by summing each branch thermal energy flow.

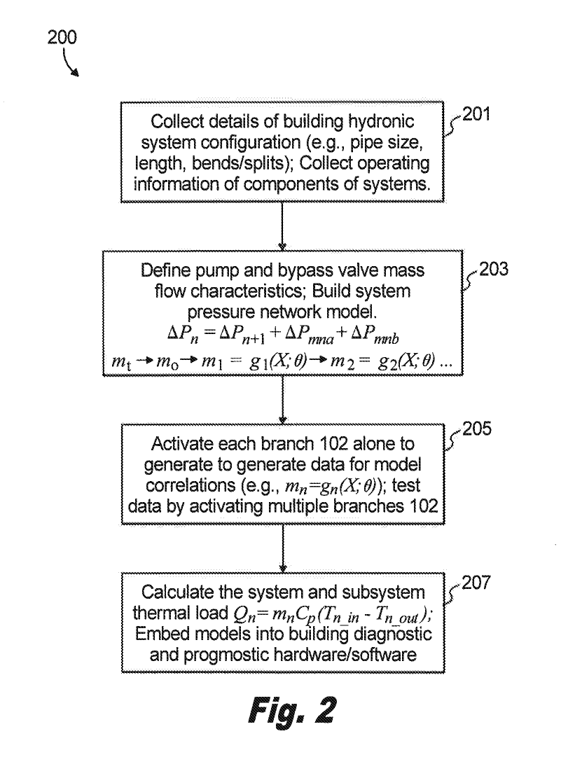

FIG. 2 shows an embodiment of a method shown in a flow chart for an embodiment of the physics based fluid flow meter. The method 200 can include collecting information including pipe network layout and the characteristics of each component (e.g., block 201), determining characteristics of one or more pumps and/or valves (e.g., block 203), constructing a pressure network model (e.g., block 203), and generating and validating AHU branch flow rate correlations (e.g., block 205). In some embodiments, the method can further include calculating thermal load (e.g., block 207).

FIG. 3 shows an embodiment of a physics based flow meter approach applied to the system 100 of FIG. 1, including a system pressure network model 315, pump curve data 317, bypass valve characteristic data 321, and semi-empirical or empirical correlations 321 for each branch. Pump curve data 317 and valve characteristic data 321 are depicted as sources of information and can be obtained from their manufacturers and/or mapped out in a lab. Semi-empirical or empirical corrections can be obtained through commissioning the system 100 or lab testing.

The cost of this approach includes the flow network model construction expenses, system commissioning and/or lab testing expenses, and embedding expense (e.g., conversion to software or hardware suitable to apply the flow model to the system). In comparison with state of the art BTU meters, this approach can dramatically reduce the material and installation costs. Related calibrations may be carried out in the lab and the commissioning and maintenance costs can also be significantly reduced.

### Hybrid Low Cost Flow Meter Embodiments

In at least one aspect of this disclosure, a hybrid flow meter can estimate flow rates using low cost sensors (temperatures, valve position etc.) by integrating the physics-based flow network model as disclosed herein and further utilize data driven statistical mapping. A problem can exist in estimating the liquid flow rate y given the information of other sensors such as valve position, inlet and outlet temperatures of liquid and air, ambient temperature, pressure drop in the liquid loop etc. All these parameters can be referred as X. The estimation of liquid flow rate can include finding an appropriate mapping function that computes the response variable (mass flow rate) from the measured inputs i.e. y=g(X; θ). In statistics, such problems are referred as regression problems, wherein the goal is to obtain the optimal values of the parameters, θ, given the parametric form of the mapping function g and some observed data. The complexity involved in the parameter estimation depends on the choice of the form of the mapping function, g.

Unlike the regression, embodiments of systems and methods disclosed herein can solve a larger problem of estimating the joint distribution (F) of the response variables and the inputs i.e. F(y, X; θ). Once a reasonably accurate joint distribution is learned, the liquid flow rate can be estimated as the conditional expected value of the response variable given the inputs i.e. E_{F}(y|X). Gaussian Mixture Models can be used for learning the joint distribution function F. The subsequent regression analysis is referred as Gaussian Mixture Regression (GMR). GMR can enable modeling of the nonlinear response surface arising due to changes in the modes of operation. In the conventional regression analysis, such nonlinearity is handled using one of the two approaches: 1) using a higher order polynomial regression model and/or 2) using a change point linear regression model that utilizes multiple piecewise linear models to capture nonlinearity. The first approach strives to fit a global response curve in the entire range of the input space. The second approach partitions the input space in multiple regions and learns a linear model in each of them.

Some embodiments described herein resemble the second approach described above with some potential differences. A first difference is that the partitions are sought in multivariate space and the partitioning algorithms are computationally efficient with analytical guarantees on convergence. On the other hand, the change point linear models typically seek partitions using ad-hoc heuristics based algorithms.

A second difference is that the aim is to learn the joint distribution of the response and the input variables, which also allows the quantification of uncertainty in the input variables. On the contrary, regression approaches (both polynomial and piecewise linear) aim to capture the uncertainty associated with only the response variable.

Regardless of which regression model is selected for estimating the flow rates, original data may be required to determine the model parameters. The data used for training and/or calibration include calculated flow rates under different input conditions.

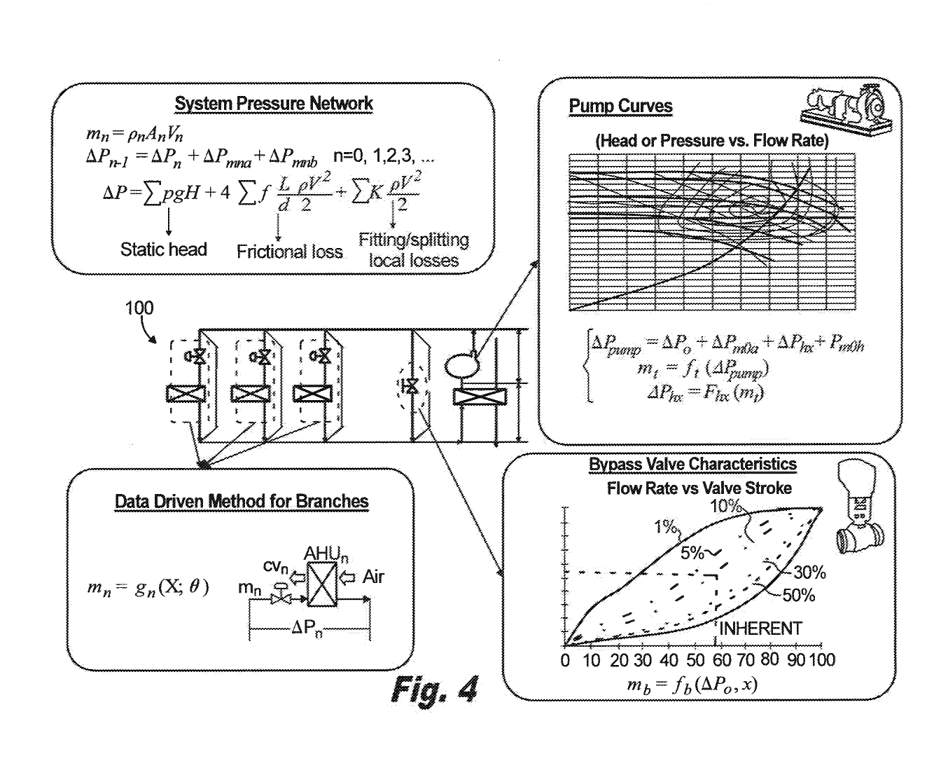

FIG. 4 shows an embodiment of a hybrid flow meter approach applied to the system 100 of FIG. 1, including a system pressure network model 315, pump curve data 317, bypass valve characteristic data 321, and data driven correlations 423 for each branch. Pump curve data 317 and valve characteristic data 321 are depicted as sources of information and can be obtained from their manufacturers and/or mapped out in a lab. As shown in FIG. 4, during the training and/or calibration, the pump map and bypass valve characteristics can be used to calculate the total flow rates across all AHU branches 102.

Through functional testing, data can be generated (ΔPₓ, mₓ et al) for each AHU 101 by closing all the other AHUs 101 and calculating pressure drops in main lines (e.g., ΔPₘₓₐ and ΔP_{mxb}) based on a bypass valve only functional test. The data generated in this way will then be used to train the models for every AHU 101. Once sufficient data is generated and the model training is completed, the models can subsequently provide the flow rates through individual AHUs 101.

In comparison with the physics based flow meter embodiments as disclosed herein, the hybrid approach can calculate flow rates in AHU branches 102 using a partially or wholly data driven statistical map instead of the semi empirical and/or empirical correlations. FIG. 4 highlights this difference. The cost of this approach is similar to that of physics based approach and mainly comes from data generation, commissioning, and implementation.

### Statistical Fluid Flow Meter Embodiments

For many retrofit and/or new buildings, detailed geometrical parameters may be not available for building a flow network model utilized in the above described embodiments. In order to solve this issue, a system functional sweeping test can map out the flow system flow characteristics under different known conditions. Once test data are generated, semi-empirical regression (e.g., GMR as disclosed above) can be used to create a polynomial formula for estimating each branch flow rate and each AHU 101 heating/cooling load.

The system functional test can include bypass valve 111 sweeping and/or AHU branch 102 sweeping for one or more branches. Before the testing, the pump and bypass valve's curves can be collected from their data sheets from their manufacturers or otherwise determined in any suitable manner. The pump curve shows the relationship between flow rate and pump head, i.e.,

ΔPₚᵤₘₚ=f(m₀)

such that ΔPₚᵤₘₚ is a function f of mass flow rate m₀, and vice versa.

The bypass valve curve shows the relationship between pressure drop, flow rate and valve opening, i.e,

ΔP₀=F(m_{b}, x_{b})

such that ΔP₀ is a function F of the mass flow rate m_{b} and percentage of valve opening x_{b}.

During the bypass valve sweeping where valve position x_{b} is varied, the bypass valve 111 opening varies while all branch control valves 103 are closed. The total flow is, thus, the same as the flow through the bypass valve such that:

m_{b}=m₀

For the fluid flow closed loop, total pressure drop ΔP along the main lines of system 100 including coils is

ΔP=ΔPₘ₀ₐ+ΔP_{m0b}+ΔPₕₓ=ΔPₚᵤₘₚ−ΔP₀

where ΔPₚᵤₘₚ is the pressure rise over pump 109, ΔP₀ is the pressure drop over the bypass valve 111, ΔPₘ₀ₐ is the pressure drop over a portion of the supply line 105 spanning from the pump 109 branch to the bypass 111 branch, ΔP_{m0b} is the pressure drop over a portion of the return line 107 spanning from the bypass 111 branch to the pump 109/heat exchanger 113 branch, and ΔPₕₓ is the pressure drop over the heat exchanger 113.

By combining the above four equations, the relationship between the flow rate and total main line pressure drop can be reduced to:

ΔP=g(m₀)

such that ΔP is a function g of flow rate m₀. In some embodiments, the sweeping test can be conducted on each branch 102 (e.g., after mapping out the mainline flow characteristics). During the sweeping, one branch valve 103 and the bypass valve 111 can be opened. The branch flow rate can be determined such that

mₙ=m₀−m_{b}

Thus, by combining the above equations, the branch flow can be calculated. In some embodiments, the collected data can be used for semi-empirical regression (e.g., after mapping out each branch control valve 103 flow characteristics).

During the functional testing, data of branch flow rate mₙ, valve opening (x) and bypass valve pressure drop ΔP₀ can be collected. According to the definition of valve coefficient Cᵥ, the data can be regressed using the following relationship:

$$\frac{{m}_{n}}{\sqrt{Δ {P}_{0}}} = {C}_{v} = f ( x ) = {a}_{0} + {a}_{1} x + {a}_{2} {x}^{2} + …$$

where x is defined as the percentage of valve opening and a₀, a₁, a₂, . . . aᵢ are coefficients of curve fitting defined by fitting a polynomial equation to the data curve generated via functional testing. For each branch 102, a semi-empirical formula can be obtained from the sweeping testing data. These polynomial regression formulae can be used for the flow rate estimation during one or more operational states.

Inlet fluid temperature Tₙ_{_}ᵢₙ (of a branch n) and outlet fluid temperatures Tₙ_{_}ₒᵤₜ (of a branch n) can be measured at any suitable time using any suitable temperature sensor or plurality thereof. Once the flow rate is calculated for each branch and the temperatures are measured, the heat flow or heat load on each AHU can be calculated by the following relationship:

Qₙ=mₙCₚ(Tₙ_{_}ᵢₙ−Tₙ_{_}ₒᵤₜ)

In comparison with the physics based meter and hybrid meter embodiments disclosed herein, the statistical fluid metering embodiments calculate flow rates through AHU branches 102 using semi-empirical formulae which are obtained from the functional testing data. Without knowing the detailed geometrical parameters of a heating or cooling system (e.g., system 100), this approach can still be utilized to virtually determine fluid flow (and thus heat flow). Thus such an approach has very high potential for building retrofit markets.

The embodiments disclosed herein and/or any suitable portions thereof can be implemented via any suitable hardware and/or software implemented on any suitable computing device (e.g., an HVAC controller, an HVAC prognostic device, an HVAC evaluative device, and the like). The hardware and/or software can be configured to execute at least a portion of any suitable method disclosed herein.

The methods and systems of the present disclosure, as described above and shown in the drawings, provide for virtual fluid flow measurement for HVAC and similar systems. While the apparatus and methods of the subject disclosure have been shown and described with reference to embodiments, those skilled in the art will readily appreciate that changes and/or modifications may be made thereto without departing from the spirit and scope of the subject disclosure.

1. An HVAC thermal energy flow measurement system, comprising:
a computerized virtual fluid flow measurement system configured to estimate a fluid flow within at least a portion of the HVAC system based on at least one HVAC system condition;
and at least one HVAC system sensor for sensing the at least one HVAC system condition, wherein the HVAC system sensor is operatively connected to the virtual flow measurement system to provide the virtual flow measurement system with the at least one HVAC system condition.

2. The thermal energy flow measurement system of claim 1, further including a physical or mathematical model, stored in a non-transitory computer readable medium therein, that represents the fluid flow for determining the fluid flow based on the at least one HVAC system condition.

3. The thermal energy flow measurement system of claim 1, further including an empirical or statistical model, stored in a non-transitory computer readable medium therein, for determining the fluid flow based on the at least one HVAC system condition, wherein the fluid flow is determined by comparing the at least one HVAC system condition to known flow data.

4. The thermal energy flow measurement system of claim 1, further including:
at least a portion of a physical or mathematical model, stored in a non-transitory computer readable medium therein, that at least partially represents the fluid flow; and
at least a portion of an empirical or statistical model, stored in a non-transitory computer readable medium therein, for determining the fluid flow based on the at least one HVAC system condition, wherein the fluid flow is determined by inputting the physical condition into the physical model and comparing the at least one HVAC system condition to known flow data.

5. The thermal energy flow measurement system of claim 1, wherein the HVAC system sensor includes at least one temperature sensor in thermal communication with at least a portion of the fluid flow.

6. The thermal energy flow measurement system of claim 5, wherein the at least one temperature sensor includes at least two temperature sensors.

7. The thermal energy flow measurement system of claim 6, wherein the at least two temperature sensors include an inlet temperature sensor disposed in thermal communication with a first portion of the HVAC and an outlet temperature sensor disposed in thermal communication with a second portion of the HVAC.

8. The thermal energy flow measurement system of claim 7, wherein the thermal energy flow measurement system is configured to determine thermal energy flow using the fluid flow and a signal from each of the inlet and outlet temperature sensors.

9. A non-transitory computer readable medium comprising computer executable instructions comprising the steps of:
receiving at least one HVAC system condition from an HVAC system sensor;
inputting the at least one HVAC system condition from the HVAC system sensor into a virtual fluid flow system to determine a fluid flow of at least a portion of the HVAC system;
outputting a fluid flow value; and
determining thermal energy flow using at least the fluid flow.

10. The non-transitory computer readable medium of claim 9, wherein inputting further includes inputting the at least one HVAC system condition into a physical or mathematical model that represents the fluid flow for determining the fluid flow based on the at least one HVAC system condition.

11. The non-transitory computer readable medium of claim 9, wherein inputting further includes inputting the at least one HVAC system condition into a statistical model for determining the fluid flow based on the at least one HVAC system condition.

12. The non-transitory computer readable medium of claim 9, further including the computer executable instructions further include performing a system functional test that includes at least one of bypass valve sweeping or branch sweeping for one or more branches of the HVAC system.

13. A method for measuring thermal energy flow in an HVAC system, comprising:
receiving at least one parameter or variable from the HVAC system;
inputting the at least one parameter or variable from the HVAC system into a virtual fluid flow system to determine a fluid flow of at least a portion of the HVAC;
outputting a fluid flow value; and
determining thermal energy flow using at least the fluid flow and a sensed temperature.

14. The method of claim 13, wherein the sensed temperature includes a first sensed temperature and a second sensed temperature from two different locations along a flow path of the fluid flow.

15. The method of claim 13, further including performing a system functional test that includes at least one of bypass valve sweeping or branch sweeping for one or more branches of the HVAC system.

16. (canceled)

17. (canceled)
